(19) United States
(12) Patent Application Publication
(10) Pub. No.: US 2006/0242357 A1
(43) Pub. Date: Oct. 26, 2006

(54) Handheld mobile communication device having a plugging expansion memory

(75) Inventors: Zechary Chang, Taipei (TW); Amy Zhang, Taipei (TW); Pinky Ma, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/113,225

(22) Filed: Apr. 25, 2005

(51) Int. Cl. G06F 12/00; G06F 13/28

(52) U.S. Cl. 711/103; 711/5

(57) ABSTRACT

A handheld mobile communication device having a plugging expansion memory includes a plugging memory module to provide a storage space to perform data access operation with the handheld mobile communication device, a storage interface module which has a first connection interface specification to provide a first transmission interface to perform data access operation, a transmission interface module which has a second connection interface specification to provide a second transmission interface to perform data access operation, a memory connection control module to integrate the storage and transmission interface modules to drive and control the plugging memory module to perform data access operation, and an internal memory module coupled with the plugging memory module through the memory connection control module to flexibly increase the data storage capacity of the internal memory module.

### FIELD OF THE INVENTION

The present invention relates to a handheld mobile communication device and particularly to a handheld mobile communication device that has a memory expandable through a plugging memory.

### BACKGROUND OF THE INVENTION

With the arrival of the information age, these days people can access and retrieve all types of information from the Internet, and download files or data into storage devices. Among the storage devices, portable storage devices (such as personal disks) are frequently used and very convenient.

A personal disk mainly consists of a flash memory. It has a lot of advantages, such as: it can be repeatedly written, it has fast access speed, it is slim and light. Hence it is very popular. But its small size and lightweight also make it easy to slip from the user's mind and is left behind when the user goes out. This often causes troubles for the user at work or while studying. To overcome this problem, some personal disks are attached to a string, to be tied to users.

On the other hand, handheld mobile communication device has almost become an indispensable communication tool for many people now. In the functions provided by the present handheld mobile communication devices, some enable users to upload or download data by linking to the Internet. This needs a dedicated data transmission line and a matching computer system. Operation is not convenient. Moreover, the data downloaded from the Internet have to be stored in the internal memory of the handheld mobile communication device. Such internal memory generally has a limited capacity. Hence users have to be discreet regard the size of the files and the capacity constraint of the memory. If the memory capacity is not enough, the data have to be transferred to a computer system to continue data access operation. Therefore to provide a device that couple the benefits of personal disk and communication function has become one of the focuses in the industry.

### SUMMARY OF THE INVENTION

In view of the aforesaid problems, the primary object of the present invention is to provide a handheld mobile communication device that has an internal memory expandable through a plugging memory. The handheld mobile communication device has an operating system to perform data transfer or access operation of the memory, to improve operation convenience of the handheld mobile communication device.

In order to achieve the foregoing object, the handheld mobile communication device according to the invention includes a plugging memory module, a storage interface module, a transmission interface module, a memory connection control module and an internal memory module.

The plugging memory module is connected to the handheld mobile communication device by plugging, to provide a storage space to perform data access operation with the handheld mobile communication device.

The storage interface module has a first connection interface specification to provide a first transmission interface (such as a Secure Digital Card—SD Card, Memory Stick Card—MS Card, and Multi Media Card—MMC) to perform the data access operation.

The transmission interface module has a second connection interface specification, differed from the first connection interface specification, to provide a second transmission interface (such as the universal serial bus—USB interface) to perform the data access operation.

The memory connection control module is connected to the storage interface module and the transmission interface module to drive and control the plugging memory module to perform the data access operation.

The internal memory module is located in the handheld mobile communication device and connected to the plugging memory module through the memory connection control module, to increase the data storage capacity of the internal memory module.

In addition, the handheld mobile communication device further includes:

a radio frequency (RF) signal processing module to receive/emit an RF signal, and process the RF signal, and transform the RF signal to a base frequency signal.

an audio coding/decoding module to code or decode audio data in the base frequency signal to provide an audio communication service.

a microprocessor module which is the nuclear module of the handheld mobile communication device, to perform signal processes for other modules. It is connected to the plugging memory module or internal memory module through the memory connection control module, to perform the data access operation.

By means of the handheld mobile communication device of the invention, the plugging memory may be coupled with the handheld mobile communication device through varying connection interfaces, to perform data transmission. Not only the storage capacity of the internal memory may be expanded flexibly, by providing data access function of the general personal disk, operation convenience of the handheld mobile communication device also is enhanced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is the system block diagram of the handheld mobile communication device of the invention; and

FIG. 2 is the system block diagram of the handheld mobile communication device of the invention coupled with a computer system.

### DESCRIPTION OF THE PREFERRED EMBODIMENTS

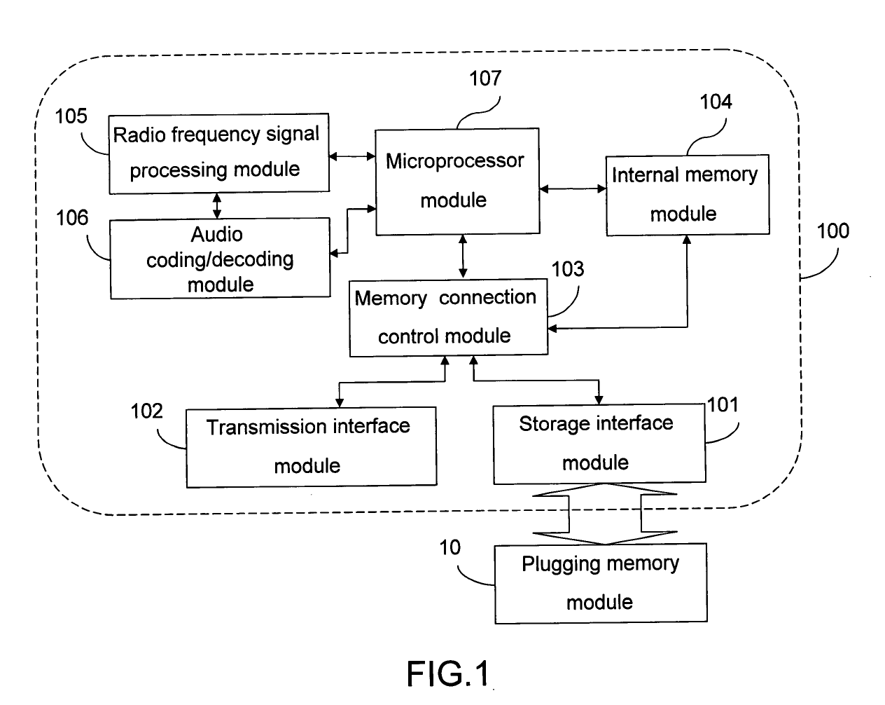

Refer to FIG. 1 for the system block diagram of the handheld mobile communication device of the invention. The handheld mobile communication device 100 according to the invention includes a plugging memory module 10, a storage interface module 101, a transmission interface module 102, a memory connection control module 103, an internal memory module 104, a radio frequency (RF) signal processing module 105, an audio coding/decoding module 106 and a microprocessor module 107.

The plugging memory module 10 is equipped with a plug-and-play connection characteristic. It is coupled with the handheld mobile communication device 100 through the storage interface module 101 by plugging, to provide a storage space to perform data access operation with the handheld mobile communication device 100. Through the plug-and-play connection characteristic, the plugging memory module 10 in the handheld mobile communication device 100 may be replaced any time desired. The plugging memory module 10 includes an SD card, MS card, MMC, and the like.

The storage interface module 101 has a first connection interface specification to provide a first transmission interface to enable the plugging memory module 10 and the handheld mobile communication device 100, to perform data access operation. The storage interface module 101 has a small memory card interface such as an SD Card, MS Card, MMC, and the like.

The transmission interface module 102 has a second connection interface specification, which differs from the interface specification of the storage interface module 101 to provide a second transmission interface for the handheld communication module 100, to perform data access operation. The transmission interface module 102 is a USB interface.

The memory connection control module 103 is connected to the storage interface module 101 and the transmission interface module 102. It has an interface conversion control circuit (not shown in the drawings) to integrate the storage interface module 101 and the transmission interface module 102 of different interface specifications, and to drive and control the data access operation of the plugging memory module 10. It also actuates data transfer between the storage interface module 101, the transmission interface module 102 or internal memory module 104. When the plugging memory module 10 is coupled with the storage interface module 101, a control signal is generated and sent to the microprocessor module 107, to recognize and use the plugging memory module 10.

The internal memory module 104 is located in the handheld mobile communication device 100 and connected to the memory connection control module 103. The data storage capacity of the internal memory module 104 may be increased through the plugging memory module 10.

The RF signal processing module 105 is connected to the microprocessor module 107 to receive/emit an RF signal through an RF antenna (not shown in the drawings), and process the RF signal, and transform the RF signal to a base frequency signal. The RF signal is used by a communication network system, which is a beehive type communication system with a frequency spectrum including GSM 900/1800/1900 MHz.

The audio coding/decoding module 106 is connected to the RF signal processing module 105, to code or decode the audio data in the base frequency signal to provide an audio communication service.

The microprocessor module 107 is the nuclear module of the handheld mobile communication device 100 to perform signal processes for other modules. It receives the control signal generated by the memory connection control module 103 to control the plugging memory module 10, to perform data access operation. The microprocessor module 107 further selects the memory (such as the plugging memory module 10 or the internal memory module 104) to perform the desired data access operation through the memory connection control module 103.

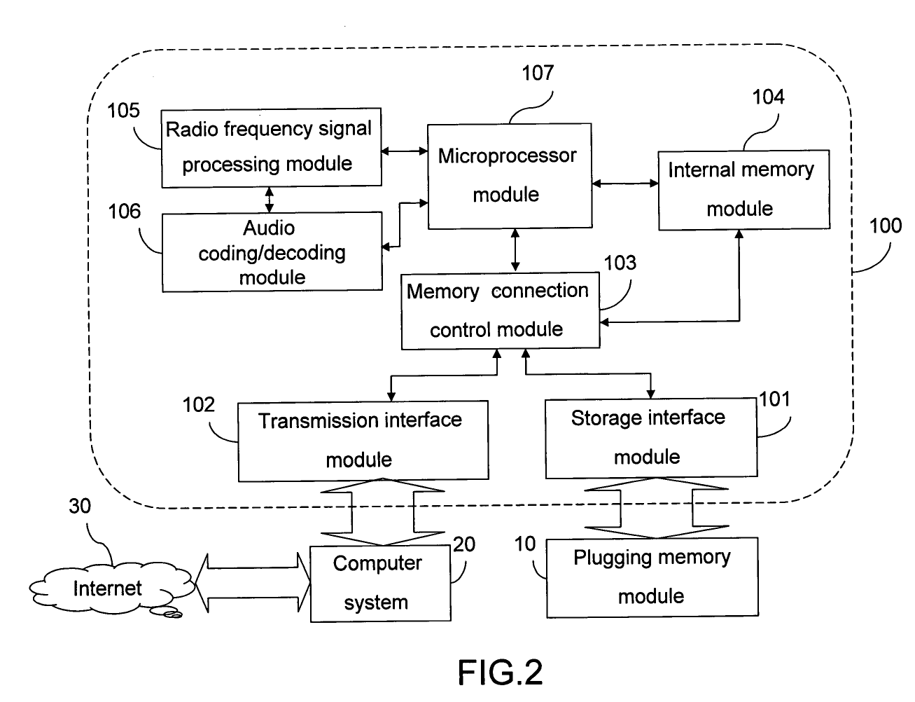

Refer to FIG. 2 for an example of the invention in use. First, when a user wants to upload/download data (such as photos, images, ring tone, or multimedia files) to/from the Internet 30 from/to the handheld mobile communication device 100, he/she connects the handheld mobile communication device 100 to a computer system 20 through the transmission interface module 102 which is a USB interface. Thus the connection with the computer system 20 can be done directly without using a special transmission line. If the capacity of the internal memory module 104 is insufficient, the plugging memory module 10 may be coupled through the storage interface module 101, and a part or all of the data (depending on the capacity of the plugging memory module 10) stored in the internal memory module 104 may be transferred to the plugging memory module 10.

Hence the handheld mobile communication device 100 is equipped with the storage property of a general personal disk. And data transfer operation of the memory can be performed through the operating system of the handheld mobile communication device 100 without the computer system. Therefore the convenience of data access is enhanced.

By means of the handheld mobile communication device with the memory capacity expandable through the plugging memory, users can couple the plugging memory with the handheld mobile communication device through various types of connection interfaces to do data transmission. Hence it not only can flexibly increase the storage capacity of the internal memory, but also provide the data access function of a general personal disk. Therefore operation convenience of the handheld mobile communication device can be enhanced.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A handheld mobile communication device having a plugging expansion memory, comprising:
a plugging memory module which is connected to the handheld mobile communication device by plugging to provide a storage space to perform data access operation with the handheld mobile communication device;
a storage interface module which has a first connection interface specification to provide a first transmission interface to perform the data access operation;
a transmission interface module which has a second connection interface specification differed from the first connection interface specification to provide a second transmission interface to perform the data access operation;
a memory connection control module which is connected to the storage interface module and the transmission interface module to drive and control the plugging memory module to perform the data access operation; and
an internal memory module which is located in the handheld mobile communication device and connected to the plugging memory module through the memory connection control module to increase data storage capacity of the internal memory module.

2. The handheld mobile communication device of claim 1 further including:
a radio frequency signal processing module to receive/emit a radio frequency signal and process the radio frequency signal, and transform the radio frequency signal to a base frequency signal;
an audio coding/decoding module to code or decode audio data in the base frequency signal to provide an audio communication service; and
a microprocessor module which is the nuclear module of the handheld mobile communication device to perform signal processes for the rest modules.

3. The handheld mobile communication device of claim 2, wherein the microprocessor module selects the plugging memory module or the internal memory module through the memory connection control module to perform the data access operation.

4. The handheld mobile communication device of claim 1, wherein the plugging memory module is coupled with the handheld mobile communication device through the storage interface module.

5. The handheld mobile communication device of claim 1, wherein the storage interface module is a Secure Digital Card (SD card).

6. The handheld mobile communication device of claim 1, wherein the storage interface module is a Memory Stick Card (MS card).

7. The handheld mobile communication device of claim 1, wherein the storage interface module is a Multi Media Card (MMC).

8. The handheld mobile communication device of claim 1, wherein the transmission interface module is a universal serial bus (USB) interface.

9. The handheld mobile communication device of claim 8, wherein the handheld mobile communication device is connected to a computer system through the transmission interface module to perform the data access operation.
